(19) United States
(12) Patent Application Publication
(10) Pub. No.: US 2010/0324745 A1
(43) Pub. Date: Dec. 23, 2010

(54) Method for estimating generation limits

(76) Inventor: Marina V. Zalevskaya, Redmond, WA (US)

Correspondence Address: Marina Zalevskaya, 15885 NE 84th Way, Redmond, WA, 98052, US

(21) Appl. No.: 12/817,195

(22) Filed: Jun. 17, 2010

Related U.S. Application Data
(60) Provisional application No. 61/187,664, filed on Jun. 17, 2009.

(51) Int. Cl. G06F 1/26

(52) U.S. Cl. 700/291

(57) ABSTRACT

Method is provided for estimating generation limits.

This application claims the benefit of Provisional Application 61/187,664 (filed on Jun. 17, 2009).

### FIELD OF THE INVENTION

The present invention is related to power generating units; specifically—to a method and system for estimating generation limits of a generating unit for current and future time periods.

### BACKGROUND OF THE INVENTION

Generation limits are the maximum and minimum capability (output) of a power generating unit.

Estimated generation limits for future time periods, e.g. Unit Planned High Net Hourly Operating Limit and Unit Planned Low Net Hourly Operating Limit, are used for resource planning; estimated current time generation limits, e.g. Generating Unit High Operating Limit and Generating Unit Low Operating Limit, are used for monitoring the generating unit.

Changes in operating limits significantly affect the economics of generating units. Consequently, accurately estimated limits may significantly impact the operating income and value of a generating asset. Error refers to the difference between the estimated and actual limit values.

Generating units most often have estimated generation limits, calculated by control and/or information systems in polynomial or tabular form as functions of operating data, such as ambient temperature and relative humidity, operating a combustion turbine with or without evaporative coolers. Formulations for calculating generation limits may be supplied by the units' equipment manufacturer and corrected based on performance tests of the units. Current methods used in estimating generation limits have accuracy problems because of the complexities and dynamic nature of generating units. For instance, units' maintenance procedures—such as combustion turbine water wash and air filter replacement—may impact actual generation limits; however, because these changes are not taken into account when estimating generation limits, they may contribute to an increased inaccuracy between the actual and estimated limits. Another issue is that measurements used in estimating generation limits may suffer from instrumentation errors, which also affects estimation accuracy. Additionally, units' particular characteristics and individual operating conditions may have an impact on unit degradation and, as a result, may likewise limit estimation accuracy. A new method to estimate generating limits—one that takes into account the difficulties mentioned above—is needed.

The importance of generation limits, especially high limits, to plant efficiency dictates the need for such an improved method of estimating generation limits.

### SUMMARY OF THE INVENTION

The present invention is a method for estimating generation limits.

### BRIEF DESCRIPTION OF THE DRAWINGS

FIG. 1 is a block diagram of the method for estimating generation limits.

### DESCRIPTION OF THE INVENTION

The present invention may be embodied as a method, system, or software program. The invention may take the form of hardware, software, or both software and hardware.

An embodiment of the present invention estimates operating limits of at least one generating unit for current and/or future time periods. The present invention can be applied to many types of generating units consisting of the various combination of equipment, including gas turbines, steam turbines, and the like. Consequently, the benefit from this invention is multifaceted—not only does the method result in more accurately-determined limits, but it is also applicable to a range of generating units.

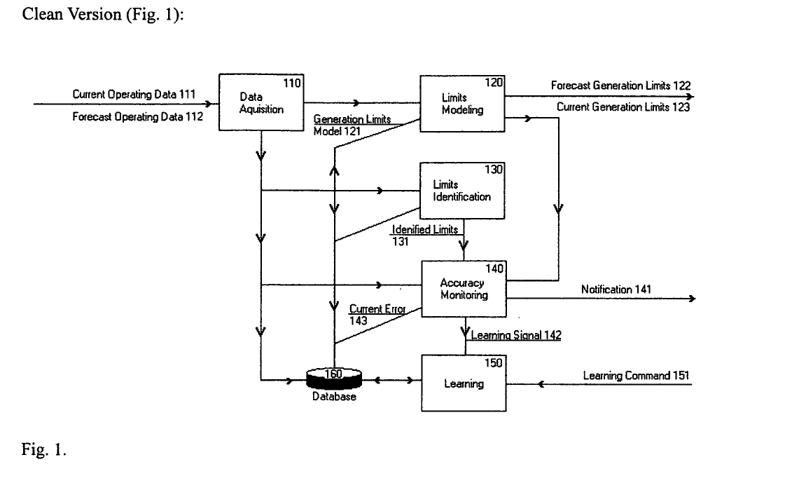

The present invention is described with references to the diagram presented in FIG. 1.

Data Acquisition block 110 receives the plurality of current operating data 111 from the generation unit's instrumentation and control system via computer communications, and/or entered manually. Current operating data may include ambient temperatures, evaporative coolers mode on or off, and the like.

Data Acquisition block 110 may receive the plurality of forecast operating data 112 via computer communications, and/or entered manually. Forecast operating data may include ambient temperatures, ambient relative humidity, barometric pressure, evaporative coolers modes on or off, running generating unit in one-on-one or two-on-one combined cycle configuration modes, and the like. Forecast operating data may have multiple alternative scenarios for a particular time interval.

Data Acquisition block 110 periodically sends operating data to Limits Modeling 120, Limits Identification 130, and Accuracy Monitoring 140 blocks, and stores the data in the Database 160.

Limits Modeling block 120 reads the generation limits model 121 from the Database 160 in the form of computer data. Block 120 calculates estimated forecast 122 and current 123 generation limits from the current and forecast operating data, and may store these limits in Database 160.

Limits Identification block 130 may determine that a unit is at its limit, by analyzing operating data, e.g. temperature limit control signal from combustion turbine control system. When the condition at which the unit is at its limit is identified, the identified limits signal 131 is sent to Accuracy Monitoring block 140, and may be stored in Database 160.

While the unit is at its limit, Accuracy Monitoring block 140 monitors current error 143, e.g. difference between actual measured current unit output and estimated current generation limit produced by Limits Modeling block 120. Accuracy Monitoring block 140 may be configured to issue a personnel notification 141 and/or learning signal 142, if the monitored current error exceeds the predetermined threshold. Error may be stored in Database 160.

Learning block 150 may be started automatically based on the learning signal 142; or by learning command 151. Block 150 reads generation limits model, history data from the Database 160. One or multiple history data time intervals may be specified. Learning block 150 produces a generation limits model, minimizing error between estimated generation limits and measured actual generation for the time periods when limits are identified. The generation limits model may be stored in Database 160.

Data Acquisition 110, Limits Modeling 120, Limits Identification 130, Accuracy Monitoring 140, Learning 150 and Database 160 blocks may send data via computer communications and/or display data on monitors.

What is claimed is:

1. A method for estimating generation limits, the method comprising:
acquiring operating data;
modeling generation limits;
identifying generation limits;
producing generation limits model.

2. The method for estimating generation limits as in claim 1, further comprising:
monitoring difference between actual measured unit output and estimated current generation limit;
optionally, issuing a personnel notification if the monitored error exceeds the predetermined threshold;
optionally, automatically producing generation limits model if the monitored error exceeds the predetermined threshold.
